(19) United States
(12) Patent Application Publication
(10) Pub. No.: US 2022/0131635 A1
(43) Pub. Date: Apr. 28, 2022

(54) SYSTEM AND METHOD FOR OPTIMIZING THROUGHPUT OF COMMUNICATION LINK

(71) Applicant: NSL COMM LTD, Airport City (IL)

(72) Inventors: Izhar MARINOV, Herzliya (IL); Uzi RAM, Givat Ela (IL)

(73) Assignee: NSL COMM LTD, Airport City (IL)

(21) Appl. No.: 17/422,762

(22) PCT Filed: Jan. 15, 2020
(86) PCT No.: PCT/IL2020/050068

§ 371 Date: Jul. 14, 2021

Related U.S. Application Data
(60) Provisional application No. 62/792,456, filed on Jan. 15, 2019.

(51) Int. Cl. H04L 1/00; H04B 7/185; H04B 7/195

(52) U.S. Cl. CPC H04L 1/0002; H04B 7/195; H04B 7/18513

(57) ABSTRACT

A system is disclosed for adaptively controlling transmission rate between first and second terminals. The system comprising a controller and a transmit unit. The controller comprising a computing unit, a storage unit and a memory unit. The transmit unit is to transmit signals over a communication link from the first terminal to the second terminal and the computing unit is adapted to receive indication of a signal-to-noise-ratio (SNR) of transmission in the communication link and to execute program stored in the memory unit to change the transmission rate of the transmit unit in response to changes in the SNR.

### FIELD OF THE INVENTION

This application is related to communication links where maximal data rate transfer is desired, in time-varying link conditions.

### BACKGROUND OF THE INVENTION

The optimization of data-rate through varying communication link conditions has become a common practice. In satellite communication links, the DVB-S2 standard supports “Adaptive” mode, such that the signal's Modulation and Coding-Rate (known as “MODCOD”) may be changed dynamically, in order to maximize the data-rate at given signal-to-noise ratio (SNR), while keeping constant transmission rate, and keeping receiver's continuous lock over the received signal. The transmission includes blocks of low density parity check (LDPC) code words with varying Coding Rate, and with varying modulation options. The adaptive operation aims to set the MODCOD figure such that the number of Data-Bits per Transmitted Symbol is maximal, while still maintaining quasi-error-free operational conditions.

### SUMMARY OF THE INVENTION

A system for adaptively controlling transmission rate between first and second terminals is disclosed comprising a controller and a transmit unit. The controller comprising a computing unit, a storage unit and a memory unit. The transmit unit is to transmit signals over a communication link from the first terminal to the second terminal and the computing unit is adapted to receive indication of a signal-to-noise-ratio (SNR) of transmission in the communication link and to execute program stored in the memory unit to change the transmission rate of the transmit unit in response to changes in the SNR.

In some embodiments the adaptive change of the transmission rate is to decrease the transmission rate by a predefined first amount when the SNR is below a predefined first threshold level and to increase the transmission rate by a predefined second amount when the SNR is below a predefined second threshold level. In some further embodiments the first and second amounts are 10% each.

In some embodiments the first threshold is 0.5 dB and the second threshold is 1.5 dB.

In some embodiments the first terminal is a communication satellite and the second terminal is a terrestrial terminal.

In some embodiments the communication satellite is a Low Earth Orbit satellite type.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram of a transmitter operating in accordance with embodiments of the present invention; and

FIG. 2 is a simplified flow chart depicting implementation of method for controlling adaptive transmission rate method according to embodiments of the invention

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

The present application is directed, in some embodiments, to maximizing the throughput of a communication link between Low Earth Orbit (LEO) Satellite, and earth station, where link distance is varying over time, and consequently the Signal to Noise Ratio (SNR) changes over time.

According to some embodiments of the present invention a system and method are suggested for increasing the available data rate at varying communication link conditions, by adaptively changing transmission rate (Rs), in addition to MODCOD changes. The adaptive change of transmission-rate may dramatically increase the data-rate compared to data-rate achieved when transmission rate is kept constant.

Some embodiments are associated with a communication link between a low earth orbit (LEO) satellite and terrestrial terminal. The ratio between the distance of the satellite from its terminal at satellite rise (or fall) time, and the shortest distance (when LEO is nearly above terminal) is typically more than 3:1, and consequently the link conditions (e.g. SNR) at rise (or fall) time are about 10 dB lower than link conditions when LEO satellite is received at high elevations. When this link is using a well-known solution, e.g. the DVB-S2 broadcast standard, the link is designed so that the rise (and fall) reception communication setting (i.e. at the lowest SNR that is acceptable by the DVB-S2 standard, that is SNR=−0 dB) which dictates the setting also for the time when the SNR is higher. The modulation that is used is Quadrature Phase Shift Keying (QPSK) and coding-rate of R=⅓. The maximal available transmission rate is denoted Rs. The data rate at rise/fall time will be about Rs*2*⅓=0.66*Rs.

Embodiments of the present invention aim to optimize the energetic efficiency of a communication link. As is known, per a given link conditions, data rate is a subject of the Energy to Noise-density ratio (Eb/No) threshold performance. The Eb/No threshold performance follows Shannon Capacity rules:

$$log ( \frac{Eb}{{N}_{0}} ) = - 1.6 ( Shannon number )$$

The transmission performance increases in proportion to the Eb/No threshold and decreases when the transmission rate increases for a constant transmission power, (and the ratio between used bandwidth and Data Rate increase). Shannon rules shows that the decrease in Eb/No threshold will reach an asymptotic floor, above Eb/No=−1.6 dB, when the used bandwidth (BW) goes to infinity. The ratio between the Eb\N0 figure and the associated added bit rate is not linear, meaning that a given addition to the Eb\N0 will contribute less addition to the bit rate than that made at lower Eb number.

Assuming the above mentioned working point, in which at the lowest SNR (i.e. rise or fall conditions), is about 0 dB. When the LEO satellite is above its terminal, SNR increases to a peak of about 10 dB, enabling communication with modulation of 16 quadrature amplitude modulation (QAM) and achieves 2.5 bits per transmitted symbol. Using a known transmission method, the transmission-rate may be changed adaptively. In such case, for the rise and fall time, it may be possible to stay at QPSK R=⅓, operating identically to the operation at DVB-S2 conditions described above, at transmission-rate of Rs, and achieving identical Data Rate of 0.66*Rs.

However, according to embodiments of the invention, the transmission rate may be changed adaptively, in proportion to SNR increase, at a given MODCOD. In the example of the satellite communication, when LEO is above the terminal, SNR conditions have improved by 10 dB, and consequently transmit at rate may be increased 10 times compared to the original Rs, while keeping the same MODCOD that was used for the reception at satellite-rise, e.g. QPSK R=⅓. Consequently, the data rate at improved communication link conditions, e.g. when LEO satellite is above its terminal, will increase to 0.66*10*Rs=6.66*Rs. Comparing the adaptive bit rate according to embodiments of the invention to the performance of the same link operated at DVB-S2 parameters with maximal data rate of 2.5*Rs, the method according to embodiments of the increases the data rate at high SNR conditions by a factor greater than 2.7.

In practice, the decoders reach low Eb/No threshold such as 0.6 dB at low coding rate of ⅓ or ¼ with BPS K (Binary Phase Shift Keying) or QPSK (Quadrature Phase Shift Keying) modulation, and the DVB-S2 lowest bit-efficient MODCOD is QPSK rate 1/4. When the communication link requires constant transmission rate, the 10 dB link improvement necessarily brings the receiver into high SNR conditions, for which the Eb/No threshold performance must increase, according to Shannon lows:

S>LOG₂(1+SNR)

Eb/No>(2^{s}−1)/S

Where:
Eb is the energy of the transmission
No is the noise density
S is spectrum efficiency, S=Rb/Rs;
Rb is Data Rate; and
Rs is transmission Rate.

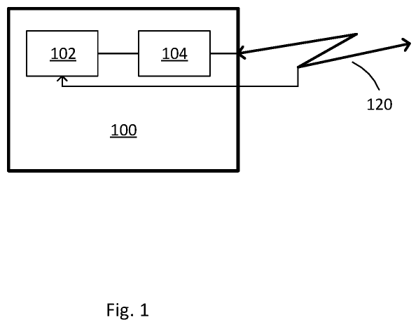

Reference is made now to FIG. 1, which is a schematic block diagram of a transmitter 100 operating in accordance with embodiments of the present invention. Transmitter 100 may include a transmission controller 102 and transmit unit 104. Data provided to transmitter 100 is transmitted to communication link 120. The link actual conditions (e.g. SNR, error rate, etc.) may be sampled and fed back to transmission controller 102. Transmission controller 102 may comprise a computing unit, memory unit, non-transitional storage unit, program storage and the like. These units are not shown in order to not obscure the drawing. The computing unit may be adapted to execute programs stored in the program storage unit.

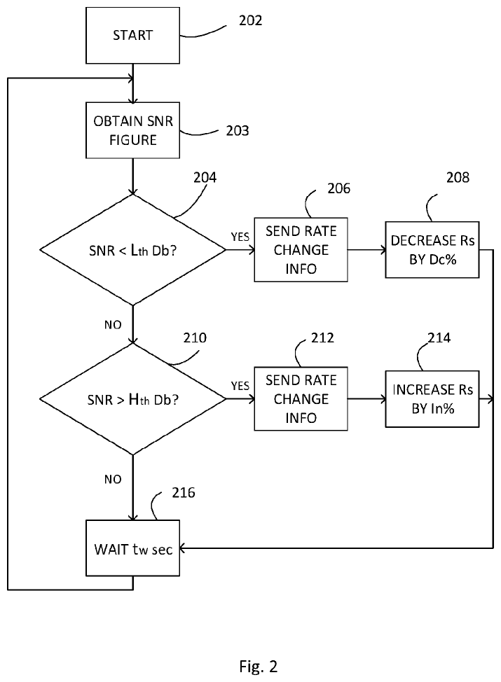

Reference made now also to FIG. 2, which is a simplified flow chart depicting implementation of controlling adaptive transmission rate method according to embodiments of the invention. The demonstrates a communication control scheme that keeps modulation and coding rate in a single MODCOD with low Eb/No threshold performance, such as QPSK R=⅓, and changes adaptively only the transmission rate, in accordance with embodiments of the present invention.

The transmitter, such as transmitter 100 of FIG. 1, receives indication 120 of the SNR at the reception site (step 203). This awareness may be implemented in a two-way communication link, where each terminal sends its reception SNR telemetry to the other terminal, in a periodic manner. Other options may include SNR estimation at the other link end, based on the calculation of the free-space attenuation with the momentary distances between terminals and LEO satellite.

The SNR figure is compared to a lower threshold Lth that may be defined (step 204). If the SNR is lower than Lth a ‘rate change’ information is sent to the transmit unit (e.g. transmit unit 104) (step 206) to decrease the transmission rate by a pre-definable ratio of Dc %. If the SNR is not lower than Lth it is compared to a upper SNR threshold Hth (step 210). If the SNR is higher than Hth a ‘rate change’ information is sent to the transmit unit (e.g. transmit unit 104) (step 212) to increase the transmission rate by a pre-definable second ratio of In %.

At the end of each cycle of testing and updating the transmission rate a definable cycle loop delay time of t_{w} seconds may be applied to set the transmission rate dynamic perform rate at a desired level.

In an exemplary embodiment when the SNR Threshold for the selected MODCOD is ˜0 dB, the transmitter will change transmission rate in order to maintain SNR in a band of 0.5 to 1.5 dB at the reception site. Each new iteration is done at the transmitter only after sufficient time from previous rate-change, that ensures lock at the terminal at the far side, as well as receiving the SNR telemetry via the satellite link.

Embodiments of the invention provide Transmission Technique and Reception Technique so that transmission rate changes in an adaptive mode, in order to maximize data rate per given communication link. In one preferred embodiment, the adaptive transmission rate may be set so that relatively low SNR is received at the far side, corresponding to low Eb/No thresholds. For example, it is possible choosing to operate at QPSK R=⅓, which gives the lowest Eb/No threshold performance, from all DVB-S2 MODCOD options. A corresponding SNR threshold is about 0 dB. In an exemplary embodiment in order to have some margin and to reduce the number of rate changes throughout the LEO satellite orbit flight, a process according to embodiments of the invention may be adapted to change transmission rate only if the far-side's SNR is out of range of, for example between Lth=0.5 to Hth=1.5.

If SNR is lower than a given low threshold, e.g., 0.5 dB, the transmitter may inform the far side of the transmission on a scheduled transmission rate change and may further reduce transmission rate by a predefined amount, say, by Dc=10%. This may yield increase of the SNR by, for example, 0.4 dB.

If SNR is above a given second, high threshold, e.g., 1.5 dB, the transmitter may inform far side on the scheduled transmission rate change and may increase the transmission rate by a given amount, e.g., by In=10%. This may yield decrease of the SNR by, for example by 0.4 dB. After each transmission-rate change, the transmitter may wait during a given time period, which may be determined as sufficient time, for example 1 second, for the receiver at the far-end to re-acquire the signal, and for the new SNR telemetry to return via the satellite link. In addition, the transmitter may limit the maximal and minimal transmission rates, in order, for instance, to limit the transmission bandwidth per receiver capabilities or satellite frequency allocation limits.

1. A system for adaptively controlling transmission rate between first and second terminals comprising:
a controller comprising:
a computing unit;
a storage unit; and
a memory unit, and
a transmit unit,
wherein the transmit unit is to transmit signals over a communication link from the first terminal to the second terminal,
wherein the computing unit is adapted to:
receive indication of a signal-to-noise-ratio (SNR) of transmission in the communication link; and
execute program stored in the memory unit to adaptively change the transmission rate of the transmit unit in response to changes in the SNR.

2. The system of claim 1, wherein the adaptively changed transmission rate is to decrease the transmission rate by a predefined first ratio when the SNR is below a predefined first threshold level and to increase the transmission rate by a predefined second ratio when the SNR is above a predefined second threshold level.

3. The system of claim 2, wherein the first and second ratios are 10% each.

4. The system of claim 3 wherein the first threshold is 0.5 dB and the second threshold is 1.5 dB.

5. The system of claim 1, wherein the first terminal is a communication satellite and the second terminal is a terrestrial terminal.

6. The system of claim 2, wherein the communication satellite is a Low Earth Orbit satellite type.

7. A method for adaptively controlling change of transmission rate between first and second terminals comprising:
transmitting by a transmit unit signals over a communication line from a first terminal to a second terminal;
receiving indication of the signal-to-noise ration (SNR) of the transmission in the communication line;
comparing the received SNR to at least one of a first and a second threshold to receive comparison result;
adaptively changing the transmission rate by a predefined amount in response to the comparison result;
repeating the steps of receiving, comparing and changing after a predefined time delay.

8. The method of claim 7, wherein the adaptively changed transmission rate is to decrease the transmission rate by a predefined first ratio when the SNR is below a predefined first threshold level and to increase the transmission rate by a predefined second ratio when the SNR is above a predefined second threshold level.

9. The method of claim 8, wherein the first and second ratios are 10% each.

10. The method of claim 9 wherein the first threshold is 0.5 dB and the second threshold is 1.5 dB.

11. The method of claim 8 wherein the communication satellite is a Low Earth Orbit satellite type.
